(19) United States
(12) Patent Application Publication
(10) Pub. No.: US 2006/0111972 A1
(43) Pub. Date: May 25, 2006

(54) Method to facilitate streaming content recipient interaction

(75) Inventor: Sundar Raman, Chicago, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 10/997,665

(22) Filed: Nov. 24, 2004

(51) Int. Cl. G06Q 30/00

(52) U.S. Cl. 705/14

(57) ABSTRACT

Non-commercial content (11) is combined (14) with a commercial message (12) that itself comprises, in part, recipient-interaction facilitation content that in turn yields a respondable commercial message (13). This combination of content is streamed (15) via a wireless broadband channel to a recipient. Upon detecting (16) a recipient interaction event, a predetermined action is taken (17). This predetermined action can comprise, for example, automated storage of the commercial message and/or supplemental information as corresponds thereto. This predetermined action can also comprise, if desired, the establishment of a communication link between the viewer and the advertiser, or such other action as may be desired.

### TECHNICAL FIELD

This invention relates generally to streaming content delivery and more particularly to the provision of commercial messages.

### BACKGROUND

Streaming media delivery systems and methodologies are known in the art. In general, streaming media comprises the real-time, near-real-time, and/or effectively real-time delivery of temporally contiguous content typically comprising video, audio, or audio-visual content. Examples include, but are not limited to, movies, sporting events, news programming, video telephony, live performances of athletic, sporting, and/or artistic events, and so forth. In general, streaming media works better with higher bandwidth delivery pathways than with narrower bandwidth delivery pathways, though improvements with respect to compression, error correction, and the like can sometimes support satisfactory reception even with narrower bandwidth systems.

In many cases, yesterday's examples of streaming content (such as television and radio broadcasting) are supported by advertising. Such advertising revenue allows content providers and distributors to increase the quality and range of their streaming content offerings. In general, however, such advertising constitutes a one-way transaction; i.e., the recipient receives the commercial offering but no specific response is usually expected aside from hoping that the recipient will, in the future, recall the advertising message and be sufficiently influenced to seek and purchase the offered product or service.

That such cause and effect occurs rarely enough is well known. Many advertisers seek to offset this relatively dismal record through repetition and relative ubiquity of their commercial messages. As streaming content viewer options increase, however, even this strategy can become cost ineffective for many advertisers.

There have been past efforts to offer the recipient other alternatives. For example, interactive television viewing generally encompasses the notion of providing a recipient with a mechanism whereby they are able to order a given advertised commodity immediately upon viewing the commercial message. Perhaps the more successful efforts in this area include so-called infomercials and home shopping channels that offer television viewers a telephone interface (that is, a toll free telephone number that the viewer can dial while watching the commercial message on television) whereby the viewers are able to enter their orders in temporal proximity to presentation of a commercial message regarding the commodity itself.

Such efforts hint at the potential of more successfully including the recipient's participation in the delivery of a commercial message, but do not fully plumb the depths of that potential. Furthermore, such prior efforts may not necessarily work as well with new streaming media delivery paradigms. For example, packet-based content delivery, such as the provision of streaming media via the Internet to portable wireless devices, anticipate in many instances a recipient who is experiencing a considerably different receiving environment than a present day shop-at-home television viewer.

### BRIEF DESCRIPTION OF THE DRAWINGS

The above needs are at least partially met through provision of the method to facilitate streaming content recipient interaction described in the following detailed description, particularly when studied in conjunction with the drawings, wherein:

FIG. 1 comprises a flow diagram as configured in accordance with various embodiments of the invention;

FIG. 2 comprises a schematic depiction of a data bearer as configured in accordance with various embodiments of the invention;

FIG. 3 comprises a block diagram as configured in accordance with various embodiments of the invention; and

FIG. 4 comprises a signal flow diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, commercial message content is combined with recipient-interaction facilitation content to provide a respondable commercial message. That respondable commercial message is then combined with non-commercial content to provide streamable content that one then streams to a recipient via, for example, a wireless broadband channel. Upon detecting recipient interaction via the recipient-interaction facilitation content, an appropriate corresponding predetermined action may then be taken to thereby facilitate subsequent interaction between the recipient and the advertiser.

The streamable content may be video, audio, or audio-video as best suits the needs and capabilities of a given setting. The respondable commercial message can be combined with the non-commercial content in any of a variety of ways, including through use of cue points as used in conjunction with automated content insertion.

The respondable commercial message can comprise a variety of different vehicles, including but not limited to information to facilitate the storage of commercial content as corresponds to a commercial message at a given storage location. These teachings are compatible with the use of various storage locations, including but not limited to network accessible storage locations and even storage locations that are associated with the recipient themselves. In addition, or in lieu of such an approach, the respondable commercial message can comprise supplemental commercial content such as an address (such as a telephone number) as corresponds to the advertiser to facilitate direct communication between the recipient and the advertiser as initiated by the recipient.

These teachings hold considerable benefit for both the advertiser and the recipient. The advertiser may well be able to avoid a shotgun approach that emphasizes product/service information ubiquity. The recipient, in turn, may be spared unrelenting repetitions of commercial messages for products or services for which they have no interest. Further, the recipient now has a tool to facilitate and further their interest upon receiving a commercial message of relevance. This, in turn, benefits the advertiser by encouraging and further inculcating a genuine sales prospect.

These and other benefits may become more evident upon making a thorough review and study of the following detailed description. Referring now to the drawings, and in particular to FIG. 1, an exemplary process 10 provides for provision 11 of data that substantially comprises non-commercial content such as a movie, a sporting event, a television program, a radio program, and so forth, which content may comprise a live performance or may be previously recorded, captured, and/or rendered. (Those skilled in these arts will recognize and understand that some non-commercial content, such as a movie, nevertheless includes some commercial content via, for example, so-called product placement, and hence the stipulation that this data “substantially” comprises non-commercial content.) As noted above, this data may comprise audio-only content, video-only content, or audio-visual data as these teachings are applicable in each such instance.

This process 10 also provides for provision 12 of at least one commercial message from an advertiser (which “advertiser” may comprise a single entity or a group of entities as the case may be). As with the non-commercial content data, this commercial message can comprise audio-only information, video-only information, or audio-visual information. In most cases, but not always, this commercial message will likely comprise a same kind of information (i.e., audio-visual, or audio-only, and so forth) as the non-commercial content itself. Accordingly, if the non-commercial content comprises, for example, an audio-visual work such as a movie, the commercial message will also typically comprise an audio-visual work.

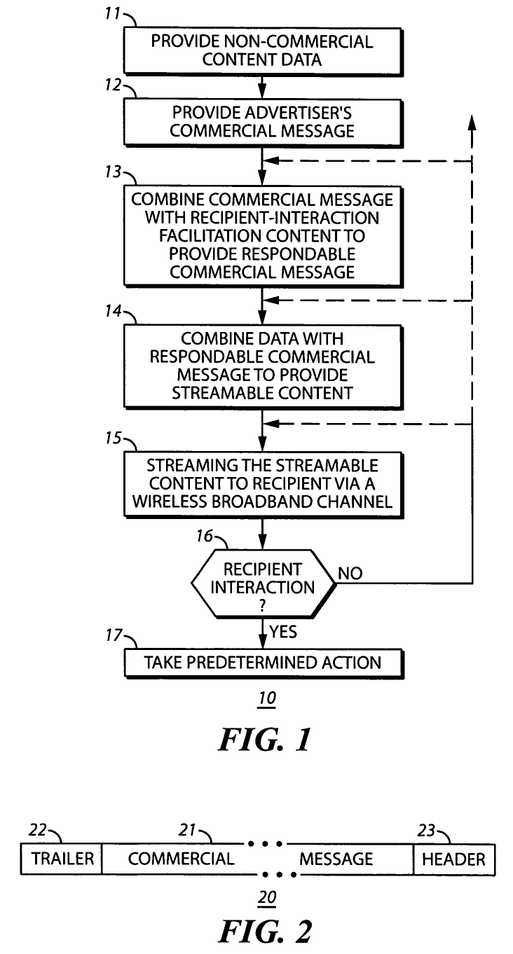

This process 10 then provides for combining 13 the at least one commercial message with recipient-interaction facilitation content to thereby provide a respondable commercial message. This recipient-interaction facilitation content should be perceivable by the recipient device (or one or more network elements on behalf of the recipient device) and may be combined or embedded in-band with the same carrier used to support or convey the commercial message itself, or it may comprise supplemental commercial content in an out-of-band carrier. The choice in this regard will likely depend upon the needs and/or capabilities inherent to a given setting and application. Pursuant to one such approach, and referring momentarily to FIG. 2, this recipient-interaction facilitation content can comprise supplemental commercial content that is combined with the commercial message 21 by including the supplemental commercial content in a trailer 22 and/or a header 23 to the commercial message 21 itself. (Such data structures are generally understood in the art. In addition, these teachings are not particularly sensitive to selection or use of any one particular such approach. Therefore, for the sake of brevity and the preservation of focus, further elaboration regarding the structure of such a combination will not be provided here.)

Referring again to FIG. 1, pursuant to some approaches, the recipient-interaction facilitation content can comprise supplemental commercial content such as an address that corresponds to the advertiser to thereby facilitate direct communications between the recipient and the advertiser as initiated by the recipient. For example, the address can comprise a telephone number, a web address, an instant message address, or the like.

Pursuant to another approach, or in combination with the above, the recipient-interaction facilitation content can comprise supplemental commercial content comprising a data storage process. As one illustrative example, such a data storage process can comprise a process to facilitate storing data as corresponds to the commercial message itself (such as an unabridged, or abridged, or expanded commercial message and/or supplemental commercial message (or messages) or other advertising content). Such a data storage process may arrange for automated and/or user or system directed storage at a storage location of choice or convenience, such as but not limited to a profile as maintained on behalf of the recipient, a local or remotely maintained schedule as corresponds to the recipient, and so forth.

Depending upon the needs and capabilities of a given application, the storage location itself may be either local or remote to the recipient. When remotely located, it may be preferable for the storage location to comprise a network accessible storage location (and preferably a storage location that is uniquely associated with the recipient) to thereby better assure subsequent access by the recipient to the stored supplemental commercial content.

In general, it will be understood and appreciated that the recipient-interaction facilitation content comprises information and/or instructions that facilitates and enables a recipient of the commercial message to gain subsequent (either immediately subsequent or at some later scheduled or unscheduled time) access to the commercial message itself and/or additional commercial information as corresponds to the content of the commercial message. This subsequent access can relate to pre-recorded material and/or can relate to a live interaction between the recipient and the advertiser (either through a live exchange with, for example, a sales representative for the advertiser and/or via a software agent or other surrogate for the advertiser as may best suit the needs of a given application).

The recipient-interaction facilitation content itself can be lightly loaded, and essentially comprise only basic contact information, or can comprise deeper and richer content such as a multimedia interactive presentation. Again, such choices will likely depend upon the specifics of a given application setting. Those skilled in the art will recognize that these teachings may be suitably employed in various such settings.

This process 10 then provides for a combination 14 of the non-commercial content data with the respondable commercial message to thereby provide streamable content. This combination can be effected in various ways. Pursuant to one approach, the combination yields an integral body of data that encompasses both kinds of information. Pursuant to another approach, the non-commercial content data may include so-called cue points. Such cue points may be automatically inserted pursuant to an algorithm of choice or by human operator selection. Such cue points may also be pre-inserted or at least pre-planned as per a given schedule, or they may be inserted on the fly during the streaming of the non-commercial content data. (The existence and use of such cue points to combine discrete messages with a larger streaming work is known and understood in the art and requires no further description here.)

When streaming 15 the above-described streamable content to a recipient via a wireless broadband channel, this process 10 then detects 16 whether and when a given recipient interacts via the recipient-interaction facilitation content of the respondable commercial message. Such interaction may be effected using any suitable and available medium, including but not limited to short message service, Internet Protocol, Session Initiation Protocol, or any other suitable transport mechanism.

In the absence of such an interaction, the above-described process continues as described (with the return point being shown in phantom lines to acknowledge that the specific point of return will vary with the specifics of a given implementation). Upon detecting such a recipient interaction, however, the process 10 takes at least a first predetermined action 17 to facilitate subsequent interaction between the recipient and the advertiser.

Again, this predetermined action can and will vary from application to application. As one illustrative example, this action may comprise storing at least a portion of the commercial message (for example, by storing this portion at a storage location as corresponds to the recipient). So configured, the recipient can re-view or otherwise re-experience the commercial message at a later time of the recipient's choosing. This, in turn, can permit a recipient to gain a better understanding of some product or service in which the recipient has interest under conditions possibly better suited to successfully imparting such information. As another illustrative example, the predetermined action may comprise facilitating a present real-time two-way voice communication between the recipient and the advertiser. This may comprise an automated dialing process and/or otherwise establishing a suitable voice link between the respective parties. The voice path itself may comprise a standard wired or wireless telephony pathway or some alternative, such as Voice over Internet Protocol.

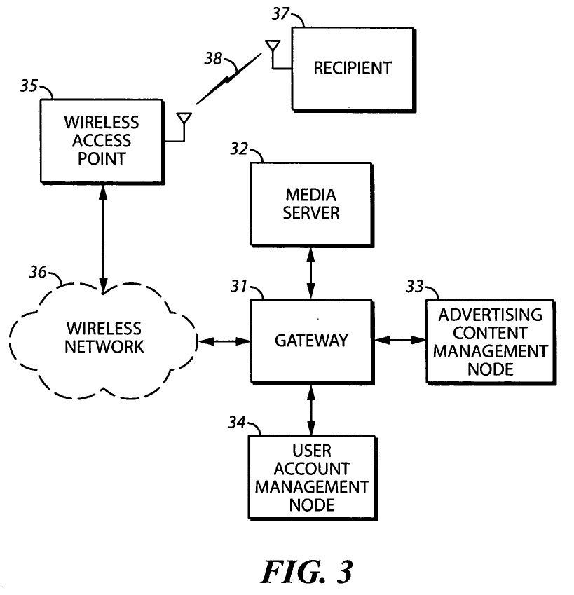

These teachings can be implemented via a variety of platforms and enabling vehicles. As one illustrative example, and referring now to FIG. 3, a gateway 31 as comprises a part of a packet data network may operably couple to a media server 32, an advertising content management node 33, and a user account management node 34. Such couplings can be supported via a variety of communications fabrics and/or architectures as will be well understood by those skilled in the art. In addition, it should be understood that these network elements comprise logical representations and may, if desired, share a single integral platform or may be further functionally parsed and distributed over a variety of other platforms. All such configurations are contemplated by and compatible with these teachings.

In such an embodiment, the media server 32 can source the non-commercial content and the advertising content management node 33 can source the commercial message (including, as appropriate, the respondable commercial message). The user account management node 34 can effect the recipient interaction activity. More particularly, the user account management node 34 can effect commercial content storage (and later retrieval, if desired) as discussed above or facilitate such other actions as may be desired and/or appropriate to a given deployment.

The gateway 31 can serve to effectively couple these network elements to a given recipient 37 via, for example, a wireless access point 35 that comprises a part of a wireless network 36 (which wireless network 36 can comprise a wide area network or a local area network). In a preferred embodiment, the radio frequency channel 38 will comprise a broadband pathway to more readily support streaming content in accord with well-understood prior art practice.

So configured, the recipient 37 can be provided with non-commercial content of interest, such as a movie, as sourced by the media server 32. From time to time, commercial content (such as an advertisement for a particular commodity) as provided by the advertising content management node 33 is combined with the streaming output from the gateway 31. Pursuant to these teachings, this commercial content includes, in part, recipient-interaction facilitation content.

Upon receiving the commercial content, the recipient can then respond in an appropriate way. The precise nature of the response can and will vary from application to application. In some deployments, the recipient's wireless device may include a user-interface (such as a particular hard or soft button) specifically dedicated to effecting such a signal. In other deployments, the advertisement may include a prompt (or a plurality of prompts) to indicate to the recipient a specific action to take in order to store the advertisement, to be automatically connected to the advertiser, or effect such other action as may be supported. For example, the commercial message may include a prompt such as, “Press 9 to store this message.” The response is then detected in such an embodiment by the gateway 31 and/or by the user account management node 34 via the gateway 31 and acted upon accordingly.

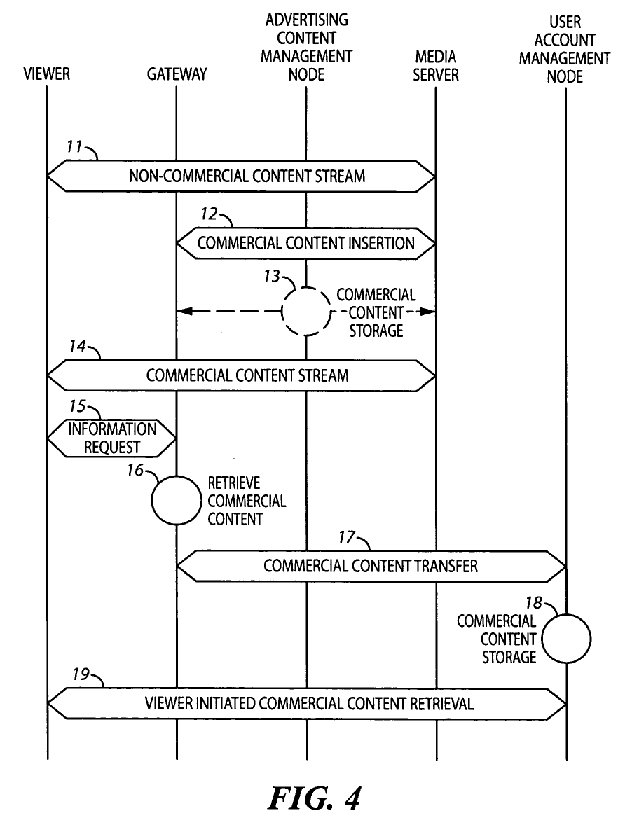

Referring now to FIG. 4, an illustrative transaction in accord with these teachings will be described. In this exemplary transaction, a media server provides non-commercial content in a stream 11 to a viewer. This content comprises, in this example, a movie-on-demand which the viewer is permitted to view without cost. From time to time, commercial content 12 is combined with the movie content via an insertion process. In this deployment, the advertising content management node stores 13 this commercial content in its entirety (locally or, if desired, at the gateway and/or the media server). Upon such insertion/combination, the commercial content is then streamed 14 to the viewer. In this example, the viewer responds with an information request 15. In response to this request the gateway effects retrieval of the commercial content 16 such that the previously stored commercial content 17 is then transferred to a user account management node where it is again stored 18. Later, at the convenience of the viewer, that commercial content 19 is recalled and retrieved for viewing by the viewer.

These teachings permit advertising to be both more effective for interested parties and less invasive for the uninterested. A content delivery system making use of these teachings can likely remain commercially viable while interrupting their programming with fewer commercial messages. This, in turn, can aid in attracting a larger audience for that system and hence aid in attracting marketers. These benefits accrue, in part, by providing the potential consumer with a bi-directional communication mechanism in the midst of a distinctly unique context and setting for such a capability. These benefits also stem, in part, from the ability of these approaches to permit the storage of commercial content for the benefit of the interested viewer and/or to otherwise facilitate the relationship between the viewer and the advertiser.

The above-described actions and reactions are readily implementable using features that are inherent in Internet Protocol communications. For example, when the streaming content is conveyed using an Internet Protocol transport, a standard protocol (or slightly modified protocol, if desired) is all that is necessary to ensure that the various parties and elements described can communicate in the manner described.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, the interactions prompted and facilitated may effect subsequent interactions with a surrogate or other agent or representative of the advertiser, as versus the advertiser itself (accordingly, the expression “advertiser” shall be understood to include both an advertiser itself and its agents and representatives).

We claim:

1. A method comprising:
providing data substantially comprising non-commercial content;
providing at least one commercial message from an advertiser;
combining the at least one commercial message with recipient-interaction facilitation content to provide a respondable commercial message;
combining the data with the respondable commercial message to provide streamable content;
streaming the streamable content to a recipient via a wireless broadband channel;
detecting interaction by the recipient via the recipient-interaction facilitation content;
taking at least a first predetermined action in response to the interaction to facilitate subsequent interaction between the recipient and the advertiser.

2. The method of claim 1 wherein the data comprises at least one of:
a movie;
a sporting event;
a television program;
a live performance;
a radio program.

3. The method of claim 1 wherein providing data further comprises providing audio-visual data.

4. The method of claim 3 wherein providing at least one commercial message further comprises providing at least one audio-visual commercial message.

5. The method of claim 1 wherein providing data further comprises audio-only data.

6. The method of claim 5 wherein providing at least one commercial message further comprises providing at least one audio-only commercial message.

7. The method of claim 1 wherein combining the at least one commercial message with recipient-interaction facilitation content to provide a respondable commercial message further comprises combining the at least one commercial message with supplemental commercial content in at least one of:
a header to the commercial message;
a trailer to the commercial message.

8. The method of claim 1 wherein combining the at least one commercial message with recipient-interaction facilitation content to provide a respondable commercial message further comprises combining the at least one commercial message with supplemental commercial content in an out-of-band carrier.

9. The method of claim 1 wherein combining the at least one commercial message with recipient-interaction facilitation content to provide a respondable commercial message further comprises combining the at least one commercial message with supplemental commercial content comprising information to facilitate storage of the supplemental commercial content as corresponds to the at least one commercial message at a given storage location.

10. The method of claim 9 wherein the given storage location comprises a network accessible storage location.

11. The method of claim 10 wherein the network accessible storage location comprises a storage location that is associated with the recipient.

12. The method of claim 11 wherein the storage location that is associated with the recipient comprises a storage location that is uniquely associated with the recipient.

13. The method of claim 1 wherein combining the at least one commercial message with recipient-interaction facilitation content to provide a respondable commercial message further comprises combining the at least one commercial message with supplemental commercial content comprising an address as corresponds to the advertiser to facilitate direct communications between the recipient and the advertiser as initiated by the recipient.

14. The method of 13 wherein the address comprises a telephone number.

15. The method of claim 1 wherein combining the at least one commercial message with recipient-interaction facilitation content to provide a respondable commercial message further comprises combining the at least one commercial message with supplemental commercial content comprising a data storage process.

16. The method of claim 15 wherein the data storage process further comprises a process to store data as corresponds to the commercial message.

17. The method of claim 16 wherein the process to store data as corresponds to the commercial message further comprises a process to store data as corresponds to the commercial message at at least one of:
a profile as corresponds to the recipient;
a schedule as corresponds to the recipient.

18. The method of claim 1 wherein combining the data with the respondable commercial message to provide streamable content further comprises entering the responable commercial message at cue points provided within the data.

19. The method of claim 1 wherein taking at least a first predetermined action further comprises storing at least portions of the commercial message.

20. The method of claim 19 wherein storing at least portions of the commercial message further comprises storing at least portions of the commercial message at a storage location as corresponds to the recipient.

21. The method of claim 19 wherein taking at least a first predetermined action further comprises facilitating a present real-time two-way voice communication between the recipient and the advertiser.
